(19) United States
(12) Patent Application Publication
(10) Pub. No.: US 2010/0201198 A1
(43) Pub. Date: Aug. 12, 2010

(54) LOW- VOLTAGE DUAL POWER LOOP DEVICE AND METHOD

(75) Inventor: KUAN-HSIUNG CHANG, SHING TIEN CITY (TW)

Correspondence Address: MOXA INC., P.O.BOX 108-00403, TAIPEI, 106, omitted

(73) Assignee: MOXA INC., SHING TIEN CITY (TW)

(21) Appl. No.: 12/368,315

(22) Filed: Feb. 10, 2009

(51) Int. Cl. H02J 1/00

(52) U.S. Cl. 307/80

(57) ABSTRACT

The present invention relates to a low-voltage dual power loop device and method, comprising a first power supply, a second power supply and a dual power control loop, wherein the first and second power supplies provide power input to the dual power control loop, which contains the first and second control chips connected with a power detection loop, a power comparison loop and a power switch loop respectively. The first and second control chips can detect the priority of the first and second power supplies by using the power detection loop. When a power outage happens to the power supply of the first priority, it will compare the voltages by using the power comparison loop and switch over from the power supply of the first priority into the standby power supply of the second priority by using the power switch loop, so that the standby power supply continues electricity supply to external electronic equipments, avoiding losses of important data in these equipments, which may result in heavy economic losses.

### BACKGROUND OF THE INVENTION

1. Field of the Invention

The present invention relates to a low-voltage dual power loop device and method, more particularly, to a power supply system in which a dual power control loop is used to detect the priority of first and second power supplies and compare their voltages at time of power outages for switch-over from the power supply of the first priority to a standby power supply of the second priority, which continues to provide electricity.

2. Description of the Prior Art

As progress in electronic science and technology leads to increasing dependence on power sources, unexpected power outages will result in losses for all industries and sectors. Especially in big electronic technology companies, there are a large number of expensive electronic system equipments installed inside, and power outages will cause economic losses that are hard to estimate. For electronic system equipments (e.g. desktop PC, bare bone system, server and network attached storage, etc), unexpected power outages will lead to the severe outcome of complete loss of the data being processed if data backup is not executed. To avoid such accidents, many kinds of uninterruptible power supplies (UPS) have been available in the marketplace, as shown in FIG. 4, which is a circuit block diagram of a UPS for conventional use. In case of a power outage, electricity will be supplied immediately from the standby power supply to electronic system equipments, so as to ensure enough time for completing data storage and shutting down these equipments, till recovery of the power supply and continuing operation of these equipments.

For the existing UPS of common use, however, many shortcomings are found in practical applications, such as:
(1) The UPS contains a charger, rechargeable batteries and other components inside it, none of which can stand high temperature. Therefore, under the circumstances of high temperatures, the UPS cannot provide power supply to electronic system equipments.
(2) Under the condition of high payloads for electronic system equipments, the master and standby power supplies of the UPS cannot be started simultaneously to supply power. Instead, it can only select the master power supply or the standby one. Therefore, the UPS cannot supply enough electricity to these electronic equipments under the condition of high payloads.
(3) The rechargeable batteries inside the standby power supply of the UPS are charged with the utility power, and supply electricity during unexpected power outages. However, these rechargeable batteries can only provide electricity for a short period of time and cannot supply enough electricity to the electronic system equipments. In such context, it's necessary to wait till supply of utility power is restored.

Thus, how to solve the problems and disadvantages of UPS of common use as mentioned above is just what the firms involved in this industry need urgently to research and improve.

### SUMMARY OF THE INVENTION

In view of the problems and disadvantages mentioned above, the inventor, after collecting related information and inviting assessments and reviews from various parties, relying on his experience of many years in this industry and through continuous trials and corrections, has finally invented the low-voltage dual power loop device and method.

The primary objective of the present invention is to enable respective input from the first and second power supplies to a dual power control loop which includes the first and second control chips inside. The first and second control chips are connected with a power detection loop, a power comparison loop and a power switch loop respectively, where the first and second control chips detect the priority of the first and second power supplies by using the power detection loop. When there is a power outage with the power supply of the first priority, the voltages of the power supplies of the first and second priorities can be compared by using the power comparison loop. And then the power switch loop will be used to switch over from the power supply of the first priority to the standby power supply of the second priority, and electricity will be supplied continuously by the standby power supply to external electronic equipments, avoiding loss of important data which may result in heavy economic losses.

The secondary objective of the present invention is to ensure that when the voltage at the power output point drops to be lower than the forward turn-on voltage of multiple diodes, the diodes connected with the first and second power supplies will be switched on, thus allowing the first and second power supplies to supply power to the power output point and standing high currents through the diodes. This will help prevent high currents from damaging multiple N-channel metal-oxide-semiconductor field effect transistors (MOSFET) and avoid breakdown of the dual power control loop.

Another objective of the present invention is to secure switch-off of the N-channel MOSFET (Q1) and N-channel MOSFET (Q2) by the first and second control chips respectively and switch-on of the multiple diodes connected with the power output point, when the voltage at the power output point drops to the lower limit voltage of either control chip. This will allow electricity supply from the first and second power supplies to the power output point at the same time, thus ensuring that external electronic system equipments can function normally even under the condition of high payloads.

### BRIEF DESCRIPTION OF THE DRAWINGS

FIG. 1 shows a block diagram of a circuit according to one embodiment of the present invention.

FIG. 2 shows a circuit diagram according to one embodiment of the present invention.

FIG. 3 is a schematic drawing according to one embodiment of the present invention.

FIG. 4 is a block diagram of a circuit in common use.

### DETAILED DESCRIPTION OF THE PREFERRED EMBODIMENT

To achieve the objectives and functions mentioned above and to describe the technology and framework adopted in the present invention, an example of the preferred embodiment of the present invention is given with reference to the accompanying drawings to describe the features and functions of the present invention in detail.

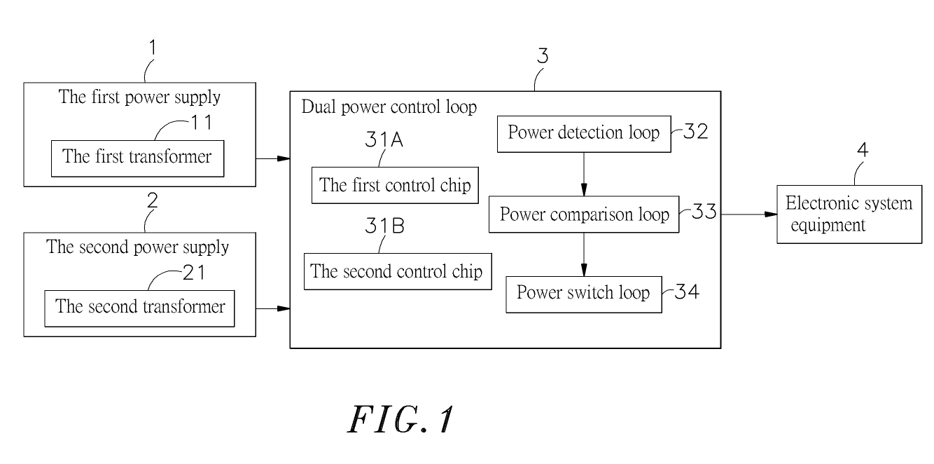

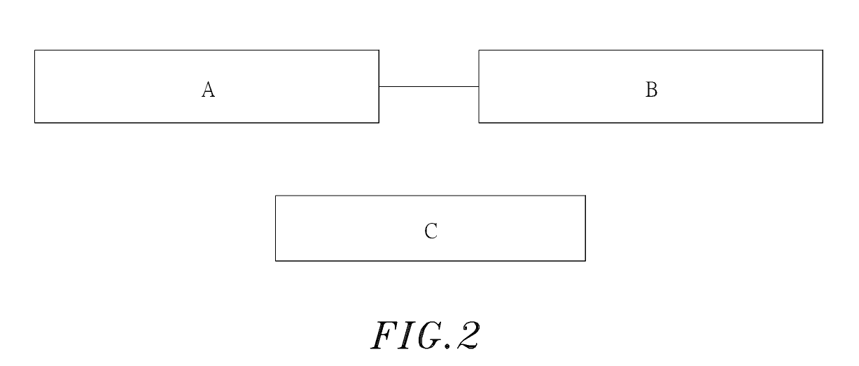

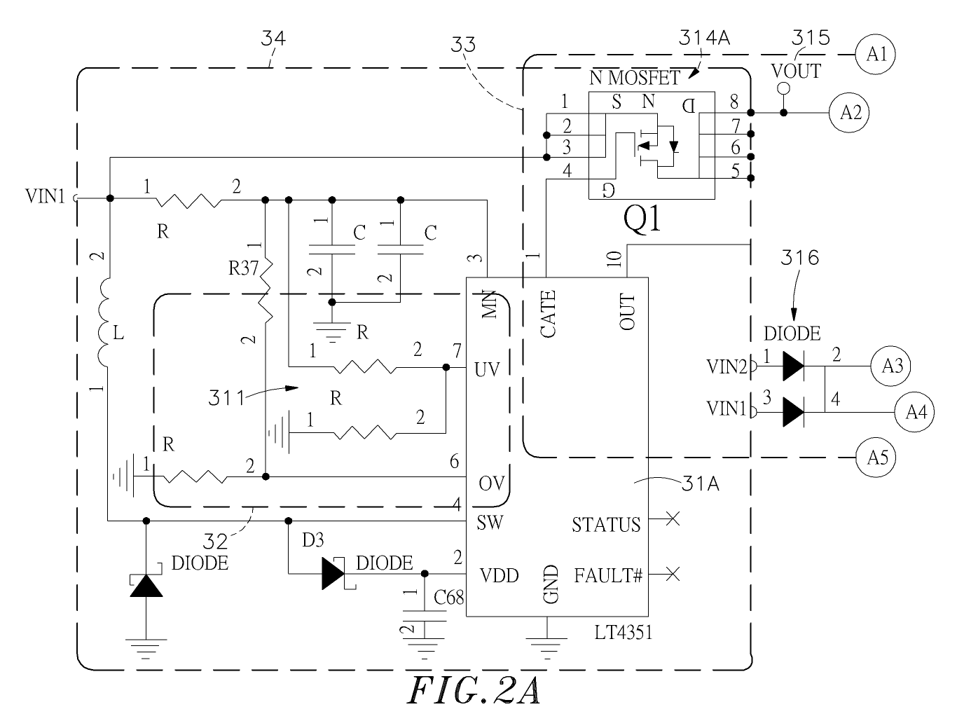

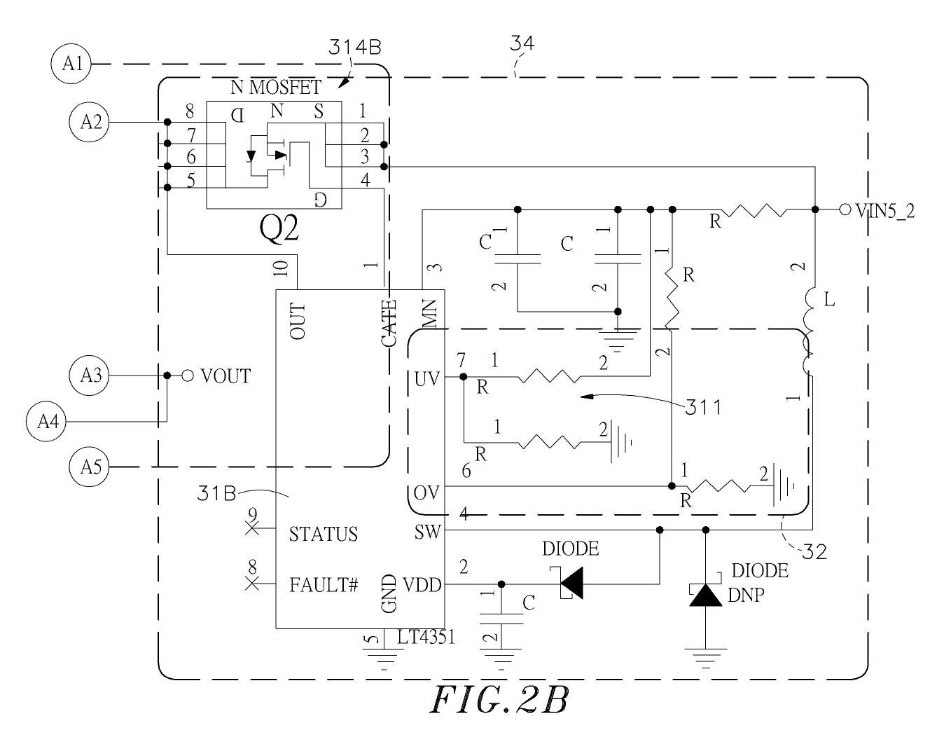

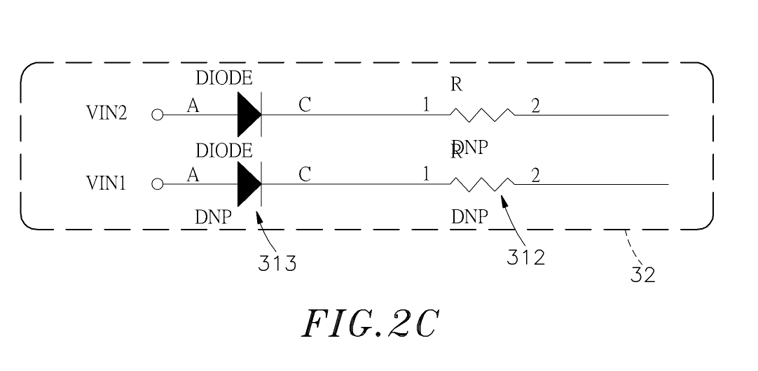

Refer to FIGS. 1 and 2, which show a circuit block diagram and a circuit diagram respectively according to one example of the preferred embodiment of the present invention. As shown clearly in these figures, the present invention comprises a first power supply 1, a second power supply 2 and a dual power control loop 3, wherein:

The first power supply 1 receives alternating current (AC) power input from utility sources, and includes a first transformer 11 that can transform AC utility power into low-voltage direct current (DC) power.

The second power supply 2 receives power input from a DC generator, and includes a second transformer 21 that can transform DC power into low-voltage DC power.

The dual power control loop 3 is connected with the first and second power supplies, and includes a first control chip 31A and a second control chip 31B. The control chips 31A and 31B are connected to a power detection loop 32 consisting of multiple voltage division resistors 311, series resistors 312 and diodes 313, and the multiple voltage division resistors 311 are connected with PIN7 of the first and second control chips 31A and 31B. While PIN6 of the first control chip 31A is connected with the first power supply 1 through the series resistors 312 and the diodes 313 sequentially, PIN 6 of the second control chip 31B is linked with the second power supply 2 via the series resistors 312 and the diodes 313 in sequence. The first and second control chips 31A and 31B are connected respectively with power comparison loop 33 that comprises N-channel MOSFET (Q1) 314A and N-channel MOSFET (Q2) 314B. Meanwhile, the PIN1 of the first control chip 31A is connected to the interpole electrode of the N-channel MOSFET (Q1) 314A, and PIN1 of the second control chip 31B is linked to the gate electrode of the N-channel MOSFET (Q2) 314B. Besides, the drain electrodes of the N-channel MOSFET (Q1) 314A and N-channel MOSFET (Q2) 314B are both connected to power output point 315, and the source electrode of the N-channel MOSFET (Q1) 314A is linked with the first power supply 1, while the source electrode of the N-channel MOSFET (Q2) 314B is connected with the second power supply 2. The first and second control chips 31A and 31B are connected respectively with the power switch loop 34, which consists of the multiple voltage division resistors 311, the series resistors 312, the diodes 313, the N-channel MOSFET (Q1) 314A and N-channel MOSFET (Q2) 314B. PIN7 of the first and second control chips 31A and 31B are connected to the multiple voltage division resistors 311, and PIN6 of the first control chip 31A is connected with the first power supply 1 via the series resistors 312 and diodes 313, with PIN6 of the second control chip 31B linked to the second power supply 2 via the series resistors 312 and diodes 313 in sequence. Furthermore, PIN1 of the first control chip 31A is connected with the interpole electrode of the N-channel MOSFET (Q1) 314A, and PIN1 of the second control chip 31B is connected with the gate electrode of the N-channel MOSFET (Q2) 314B. In addition, both drain electrodes of the N-channel MOSFET (Q1) 314A and MOSFET (Q2) 314B are connected to the power output point 315, and the source electrode of the N-channel MOSFET (Q1) 314A is linked with the first power supply 1, and the source electrode of the N-channel MOSFET (Q2) 314B is connected with the second power supply 2.

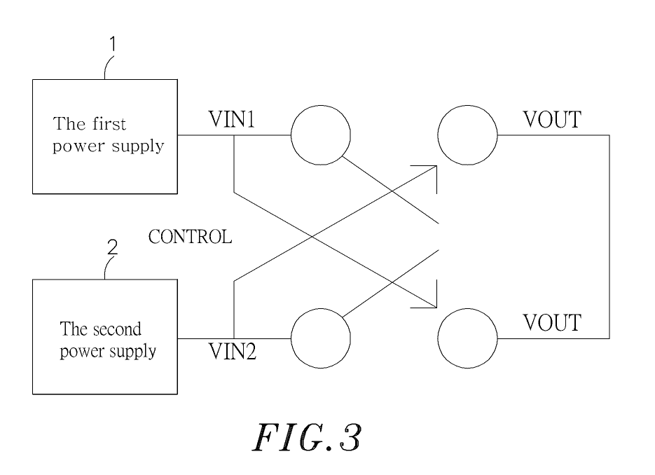

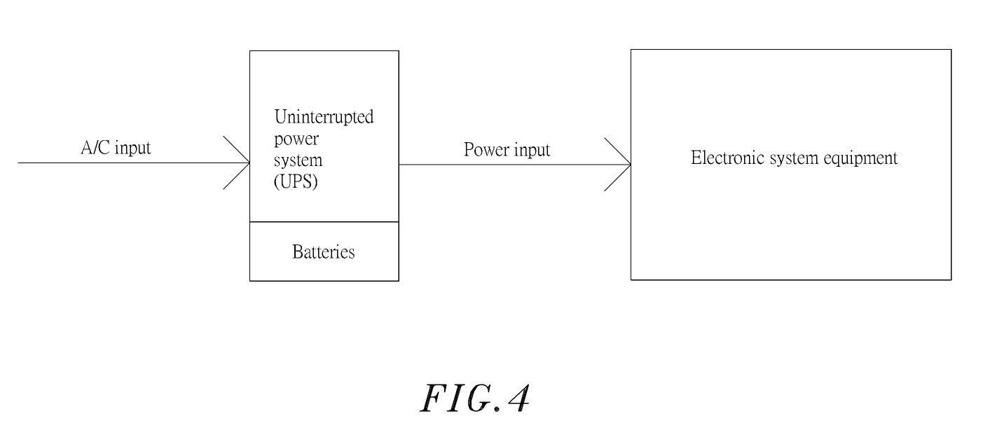

Refer to FIGS. 2 and 3, which show a circuit diagram and schematic drawing of the present invention. The figures show clearly that the 100-240V AC utility power is inputted into the first power supply 1, and that the AC utility power is transformed by the first transformer 11 inside the first power supply into low-voltage DC power, and then supplied to the dual power control loop 3, while the 24-48V DC power is supplied from the DC generator to the second power supply 2, in which the 24-48V DC power is transformed by the second transformer 21 into DC power of lower voltages, e.g. 5V, and then supplied from the second power supply 2 to the dual power control loop 3. The series resistors 312 of the power detection loop 32 are connected with the first and second power supplies 1 and 2 respectively, yet the diodes 313 are connected with either the first power supply 1 or the second power supply 2 according to factory settings. Moreover, if the diodes 313 are connected with the first power supply 1 instead of the second power supply 2, the first and second control chips 31A and 31B will set the first power supply 1 as the mast power source of the first priority, and identify the second power supply as the standby power source of the second priority. In this context, the first and second control chips 31A and 31B will shut down the second power supply 2, and will compare the voltages of the first and second power supplies 1 and 2 that are connected to the N-channel MOSFET (Q1) 314A and MOSFET (Q2) 314B respectively by using the power comparison loop 33. If the voltage of the first power supply 1 is higher than that of the second power supply 2, power switch loop 34 will switch over from the second power supply 2 to the first power supply 1.

Refer to FIGS. 1 and 2. As clearly shown in these figures, when the power switch loop 34 performs switch-over between the first and second power supplies 1 and 2, the power output point 315 is connected with the first power supply 1 and the second power supply 2 respectively via multiple diodes 316, since there is delayed power outage in the process of switch-over. When the voltage at the power output point 315 grows lower than 0.4V, the diodes 316 connected with the first and second power supplies 1 and 2 will be switched on at first, but not the N-channel MOSFET (Q1) 314A and MOSFET (Q2) 314B, because the forward turn-on voltage between the multiple diodes 316 is 0.4V, while the voltage between the N-channel MOSFET (Q1) 314A and MOSFET (Q2) 314B is 0.7V. This allows the first and second power supplies 1 and 2 to supply electricity to the power output point 315, and the multiple diodes 316 can bear high currents and prevent high currents from destroying the N-channel MOSFET (Q1) 314A and MOSFET (Q2) 314B, thus protecting these transistors.

In addition, the power output point 315 of the dual power control loop 3 can be connected with external electronic system equipments 4 for supply of electricity. If the first power supply 1 is identified as the master power source and the external electronic system equipments 4 have high payloads, the voltage of the power output point 315 will drop. When the voltage drops to the lower limit voltage of the first control chip 31A, for example, from 5V to 4.5V, the first control chip 31A will shut down the N-channel MOSFET (Q1) 314A. At the same time, a voltage difference of over 0.4V will be generated between the multiple diodes connected with the power output point 315, thus making the diodes 316 be switched on and enabling the first and second power supplies 1 and 2 to simultaneously supply electricity to the power output point 315.

When practically applied, the low-voltage dual power loop device of the present invention has such advantages as follows:
(1) It includes the power comparison loop to compare voltages and allows the power switch loop to switch over from the power supply of the first priority to the standby power supply of the second priority for continued electricity supply to external electronic system equipments, thus avoiding loss of important data in these equipments, which may cause significant economic losses due to power outages.
(2) The multiple diodes 316 can bear strong currents and protect the N-channel MOSFET (Q1) 314A and MOSFET (Q2) 314B by preventing high currents from damaging these transistors, thus further preventing other components in the dual power control loop 3 from being damaged.
(3) When the voltage at the power output point 315 drops to below 0.4V, the diodes 316 connected with the first and second power supplies 1 and 2 will be switched on, allowing the first and second power supplies 1 and 2 to supply electricity to the power output point 315. Therefore, there will be no delayed power outage during the power switch.
(4) The first control chip 31A will turn off the N-channel MOSFET (Q1) 314A if the voltage drops to the lower limit voltage of the control chip. At the same time, forward turn-on of the multiple diodes 316 will be fulfilled. This will enable the first and second power supplies 1 and 2 to supply electricity to the power output point 315 simultaneously, allowing the external electronic system equipments 4 to continue to work even under the condition of high payloads.

In summary, the present invention mainly applies the dual control chip to detect the priority of the first and second power supplies by using the power detection loop, makes a comparison of voltages through the power comparison loop, and then employs the power switch loop to achieve switch-over between the first and second power supplies. In case of power outages, it can switch over to the first or second power supplies for supplying electricity to external loads. However, it should be noticed that the aforesaid descriptions are given to illustrate one example of the preferred embodiments of the present invention and shall not be construed to limit the scope of the appended claims of the present invention. It is hereby stated that all other modifications and equivalent structural changes made without departing from the spirit of the art and technology disclosed in the present invention shall be included within the scope of the appended claims of the present invention.

To summarize the descriptions given above, the low-voltage dual power loop device and method disclosed in the present invention, once applied, can really achieve its functions and objectives. Therefore, the present invention is really an excellent one with practical applicability, and can satisfy conditions for patentability of a utility model. While the application of patent is filed pursuant to applicable laws, your early approval of the present invention will be highly appreciated so as to guarantee benefits and rights of the inventor who has worked hard at this invention. For any question, please do not hesitate to inform the inventor by mail, and the inventor will try his best to cooperate with you.

What the invention claimed is:

1. A low-voltage dual power loop device, comprising a first power supply, a second power supply and a dual power control loop, wherein,
The first power supply includes a first transformer that can transform the voltage of power from an external source;
The second power supply contains a second transformer that can transform the voltage of power from an external source;
The dual power control loop is connected with the first and second power supplies respectively, and includes a first control chip and a second control chip, both of which are linked respectively to a power detection loop that can detect the priority of power supplies; Further, the first and second control chips are connected respectively with the power comparison loop that can be used to compare the voltage of the first power supply with that of the second power supply; Besides, the first and second control chips are linked respectively with a power switch loop that can switch over between the first and second power supplies.

2. The low-voltage dual power loop device according to claim 1, wherein the power detection loop comprises at least multiple voltage division resistors, series resistors and diodes.

3. The low-voltage dual power loop device according to claim 2, wherein PIN7 of the first and second control chips are connected with the multiple voltage division resistors, and PIN6 of the first control chip is connected via the series resistors and diodes in sequence to the first power supply, while PIN6 of the second control chip is linked to the second power supply through the series resistors and diodes in sequence.

4. The low-voltage dual power loop device according to claim 1, wherein a power comparison loop comprises at least an N-channel field effect transistor (MOSFET) (Q1) and an N-channel MOSFET (Q2).

5. The low-voltage dual power loop device according to claim 4, wherein PIN1 of the first and second control chips linked with the power comparison loop are connected with the interpole electrode of the N-channel MOSFET (Q1) and the gate electrode of the N-channel MOSFET (Q2) respectively; While both drain electrodes of the N-channel MOSFET (Q1) and N-channel MOSFET (Q2) are connected to the power output point, the source electrode of the N-channel MOSFET (Q1) is connected to the first power supply, yet the source electrode of the N-channel MOSFET (Q2) is linked with the second power supply.

6. The low-voltage dual power loop device according to claim 1, wherein a power switch loop comprises at least the multiple voltage division resistors, the series resistors, the diodes, the N-channel MOSFET (Q1) and N-channel MOSFET (Q2).

7. The low-voltage dual power loop device according to claim 6, wherein PIN7 of both the first and second control chips are connected with the multiple voltage division resistors, and PIN6 of the first control chip is linked sequentially via the series resistors and the diodes to the first power supply, while PIN6 of the second control chip is connected to the second power supply through the series resistors and diodes in sequence; Besides, PIN1 of the first and second control chips are linked to the interpole electrode of the N-channel MOSFET (Q1) and the gate electrode of the N-channel MOSFET (Q2) respectively, and both drain electrodes of the N-channel MOSFET (Q1) and MOSFET (Q2) are connected to the power output point; The source electrode of the N-channel MOSFET (Q1) is connected with the first power supply, and of the N-channel MOSFET (Q2), linked with the second power supply.

8. The low-voltage dual power loop device according to claim 1, wherein the power output point of the power control loop is connected respectively with the first and second power supplies with the multiple diodes.

9. The low-voltage dual power loop device according to claim 1, wherein the first power supply can receive alternating current (AC) power input from a utility source and include the first transformer used to transform the AC utility power into direct current (DC) power of lower voltages.

10. The low-voltage dual power loop device according to claim 1, wherein the second power supply can receive DC power input from DC power generators and includes the second transformer that transform the DC power into DC power of lower voltages.

11. A low-voltage dual power loop method, wherein the first and second power supplies provide electricity respectively to the dual power control loop, and there are diodes connected between the first power supply and the series resistors, but there is no diode installed between the second power supply and the series resistors; Then, the first and second control chips will identify the first power supply as the master power source of the first priority, and set the second power supply as the standby power source of the second priority, enabling these control chips to detect the priority of the both power supplies with aid of the power detection loop, and to compare the voltages of the first and second power supplies that are connected with the N-channel MOSFET (Q1) and MOSFET (Q2) respectively; If the voltage of the first power supply is higher than that of the second power supply, the power switch loop will perform switch-over to the first power supply, which will provide electricity to the power output point.

12. The low-voltage dual power loop method according to claim 11, wherein the power output point is connected with the first and second power supplies as well as external electronic system equipments respectively through the multiple diodes; If there is any delayed power outage in the process of switch-over by the power switch loop between the first and second power supplies, making the voltage of the power output point grow lower than 0.4V, the diodes connected with the first and second power supplies will be switched on, but the N-channel MOSFET (Q1) and MOSFET (Q2) will not be switched on; As a result, the first and second power supplies will supply electricity to the power output point; Meanwhile, these multiple diodes can bear strong currents and protect the N-channel MOSFET (Q1) and MOSFET (Q2) by preventing strong currents from damaging these transistors.

13. The low-voltage dual power loop method according to claim 11, wherein the power output point is connected through the multiple diodes with the first and second power supplies as well as external electronic system equipments respectively; When the first power supply is set as the master power source and the external electronic system equipments are burdened with heavy payloads, the voltage of the power output point will drop; If the voltage drops to the lower limit voltage of the first control chip, the control chip will shut down the N-channel MOSFET (Q1) and switch on the multiple diodes as there is voltage difference between the multiple diodes connected with the power output point to trigger the switch-on action, thus making the first and second power supplies to provide power to the power output point at the same time.
